(19) United States
(12) Patent Application Publication
(10) Pub. No.: US 2006/0014917 A1
(43) Pub. Date: Jan. 19, 2006

(54) Moisture-curing polyurethane material having a long gel time

(75) Inventors: Thomas Garrett, Corona, CA (US); Xian Xian Du, Pittsburg, KS (US)

Correspondence Address: CROWELL & MORING LLP;INTELLECTUAL PROPERTY GROUP, P.O. BOX 14300, WASHINGTON, DC, 20044-4300, US

(73) Assignee: MCP Industries, Inc.

(21) Appl. No.: 11/153,948

(22) Filed: Jun. 16, 2005

Related U.S. Application Data
(63) Continuation-in-part of application No. 10/150,182, filed on May 16, 2002.

(51) Int. Cl. C08G 18/00

(52) U.S. Cl. 528/44

(57) ABSTRACT

A polyurethane adhesive composition having a long pot life that does not cause its user to experience breathing difficulty is described. In one embodiment, the adhesive is prepared from a mixture of a high molecular weight component, an isocyanate, and a proton donor.

### CROSS REFERENCE TO RELATED APPLICATION

This application is a continuation-in-part of U.S. patent application Ser. No. 10/150,182, filed on May 16, 2002, which is hereby fully incorporated herein.

### 1. FIELD OF THE INVENTION

The invention relates in general to a novel one component polyurethane adhesive and binding material and, more particularly to a novel polyurethane adhesive having a relatively long pot life.

### 2. BACKGROUND

Athletic tracks are commonly surfaced with a mixture of a moisture-curing polyurethane binder and recycled rubber crumb. The selection of the components of the binder is influenced by several factors including the cost of the components, the physical properties of the binder, and the quality of the resulting product. Additionally, a polyurethane binder having volatile irritating components is objectionable to individuals who must use the material regularly.

Two formulations of a polyurethane binder are in common use: one containing methylene diphenyl diisocyanate (MDI), and another containing a mixture of toluene diisocyanate (TDI) and MDI. The moisture-curing one component adhesive binder that employs only MDI as the polyisocyanate component is inexpensive and safer to use than the TDI-containing binder. However, the commonly used MDI-only binder does not have a long pot life and typically gels in 1-1.2 hours. An adhesive's pot life is the length of time during which an adhesive remains suitable for use. A long pot life is important in applications such as athletic track surfacing because several hours may be required to apply the track material. Additionally, the material that is applied initially can be required to form a joint with the material that is applied last. Ideally, the joint between the material that is applied first and the material that is applied several hours later should be as seamless and aesthetically pleasing as possible. To prevent a seamed joint from forming that is undesirably susceptible to wear and potentially dangerous to the users of the track, the polyurethane material must not have completely cured before installation is complete. Adhesives with a long pot life, that are still workable when the final material is applied, form joints that are nearly, if not entirely, seamless. A long pot life provides a long working time to construct a resilient surface and creates a more seamless, aesthetically pleasing result.

The second commonly used moisture-curing one component polyurethane binder formulation, that employs TDI, is a popular choice in the athletic surfacing industry because the binder has a long pot life, typically 7 hours, and the resulting product demonstrates good physical properties. Unfortunately, because of the high vapor pressure of TDI, formulations containing TDI are unpleasant to work with. Health risks of an adhesive formulation containing TDI can include irritation of the nose and throat; choking and paroxysmal cough; chest pain and retrosternal soreness; nausea, vomiting, and abdominal pain; bronchial spasm; dyspnea, asthma, and pulmonary edema; and conjunctivitis and lacrimation (from the Merck Index, 12^{th} edition, 9668).

Both the currently used formulations, the TDI-containing and MDI-only polyurethane binders, use prepolymer mixtures having an excess of isocyanate groups. The TDI binders are obtained by reacting TDI and MDI with a polyol, typically a polyether or polyester polyol. The MDI-only binders are obtained from the reaction of a polyol with an excess of MDI. The TDI and MDI-only binders harden through reaction with atmospheric moisture.

### SUMMARY OF THE INVENTION

A moisture-curing polyurethane material having a long gel time is disclosed. In one embodiment, a moisture-curing adhesive polyurethane composition comprises a high molecular weight component selected from the group consisting of polyols, polyamines, and mixtures thereof; a proton donor; and a polyisocyanate comprised of a mixture of a first isocyanate isomer and a second isocyanate isomer, wherein the first isocyanate isomer has a faster reaction rate than the second isocyanate isomer, and wherein the first isocyanate isomer reacts with the proton donor to increase a relative concentration of the second isocyanate isomer as a percentage of total unreacted isocyanates.

In one embodiment, a 4-position isocyanate reacts with the proton donor to increase the concentration of a 2-position isocyanate as a percentage of the total unreacted isocyanates.

Other embodiments are disclosed and claimed herein.

### BRIEF DESCRIPTION OF THE DRAWINGS

FIG. 1 compares the measured tensile strength of thin film samples of the prior art MDI-only and TDI binders to the tensile strength of several binders made according to the examples described herein;

FIG. 2 compares the gel times of the prior art MDI-only and TDI binders to the gel times of several binders made according to the examples described herein.

FIG. 3 is one embodiment of an NMR spectra of a prepolymer prepared in accordance with principles of the invention; and

FIGS. 4A-4B are embodiments of molecular representation of compounds found in one or more embodiment of the invention.

### DETAILED DESCRIPTION OF EXEMPLARY EMBODIMENTS

One aspect of the invention relates to one component moisture-curing polyurethane adhesives that have a long pot life but that do not necessarily employ TDI. Binders that do not employ TDI avoid the health risks associated with the use of TDI. The disclosed adhesives may be useful in situations in which a polyurethane adhesive, binder, sealant, spray elastomer, or caulking material with a long pot life is desired. These moisture-curing adhesives are useful, for example, as binders for rubber crumb, plastic particles, cork particles, or glass fibers. A composite prepared from mixing rubber, cork, or resilient plastic crumb with the polyurethane binder can be used to create resilient surfaces for athletic activity, such as tracks, fields, playgrounds, or playstructures, or to create resilient molded structures having any size or shape. In one embodiment, an adhesive consistent with the principles of the invention may demonstrate good adhesion to a variety of substances, including polyurethane, rubber, plastic, glass, metal, asphalt, concrete, wood, and paper.

One embodiment of the invention employs a mixture of a proton donor (e.g., a chain extender), a high molecular weight polyol or polyamine, and a polyisocyanate. It is common in the art to use chain extenders to increase the amount of the hard segment of the polyurethane block copolymer and thereby increase the physical properties of the resulting polymer (i.e., tensile, tear, and elongation). However, one aspect of the invention is for the proton donor to be used to preferentially react off the 4-position isocyano group in order to increase the relative amount of 2-position isocyanate. It should further be appreciated that any n-functional proton donor may be used to increase the amount of 2-functional isocyanate, where n may vary from 1 to 8. While in one embodiment a mono-functional proton donor may be used, in another embodiment a di- or poly-functional proton donor may similarly be used, depending on the characteristics of the desired characteristics of the resulting polyurethane adhesive. Using a proton donor to increase the relative amount of 2-functional isocyanate results in a significantly longer pot life, according to one embodiment. The proton donor contains at least one active hydrogen, which are functional groups from which a proton can be removed with moderate base (e.g., alcohol groups, amines, water, etc.).

One proposed mechanism for increasing the relative amount of 2-position isocyanate is to use chain extenders to “block” the 4-position isocyano. The use of chain extenders may have the added benefit of not dramatically changing the other characteristics of the resulting polymer, such as viscosity and durometer. In contrast to the general expectation of one skilled in the art, i.e., that the addition of a chain extender will not have an effect on or that a chain extender might even decrease pot life, it was found that adding chain extenders to polyurethane adhesives produced adhesives with significantly longer pot lives.

In one embodiment, the invention specifically comprises an adhesive composition made from a mixture of about 50 to about 80% by weight of a high molecular weight component selected from the group consisting of polyols, polyamines, and mixtures of polyols and polyamines, about 19 to about 44% by weight of a polyisocyanate, and about 0.1 to about 3% by weight of an active hydrogen compound from which a proton can be removed with a moderate base. In one embodiment, this active hydrogen compound is a low molecular weight component selected from the group consisting of diols, polyamines, and mixtures of diols and polyamines. In general, the amount of high molecular weight component in the mixture as measured by parts per hundred, weight/weight, may range from about 50 to about 80. Specifically, the concentration of the high molecular weight compound may be 55, 60, 66, 70, 72, 74, 77, or about 80. The amount of polyisocyanate in the mixture as measured by parts per hundred, weight/weight, is about 19, but may also be 21, 24, 27, 30, 34, 38, or about 44. The amount of low molecular weight component as measured by parts per hundred, weight/weight, is about 0.1, but may similarly be about 0.2, about 0.3, about 0.4, about 0.5, about 0.7, about 0.8, about 1, about 1.5, about 2, about 2.5, or about 3.

In another embodiment, or in addition to one or more of the previous embodiments, the adhesive composition is made from a mixture of about 60% to about 80% by weight of a high molecular weight component selected from the group consisting of polyols, polyamines, and mixtures of polyols and polyamines; about 19 to about 38% by weight of a polyisocyanate, and about 0.1 to about 3% by weight of a low molecular weight component selected from the group consisting of diols, polyamines, and mixtures of diols and polyamines. In an additional embodiment, the adhesive composition is made from a mixture of about 66 to about 77% by weight of a high molecular weight component selected from the group consisting of polyols, polyamines, and mixtures of polyols and polyamines; about 21 to about 33% by weight of a polyisocyanate, and about 0.1 to about 2% by weight of a low molecular weight component selected from the group consisting of diols, polyamines, and mixtures of diols and polyamines. In a further embodiment, the adhesive composition is made from a mixture of about 70 to about 74% by weight of a high molecular weight component selected from the group consisting of polyols, polyamines, and mixtures of polyols and polyamines; about 24 to about 30% by weight of a polyisocyanate, and about 0.1 to about 1% by weight of a low molecular weight component selected from the group consisting of diols, polyamines, and mixtures of diols and polyamines.

In general, the high molecular weight polyols and polyamines useful in the invention can have various polymeric backbones, such as polyether, polyester, or polybutadiene. These high molecular weight polyols and polyamines typically have a molecular weight from about 1,000 to about 11,200. In one embodiment, the moleculat weight range may be from about 2,000 to about 9,000, from about 3,000 to about 8,000, or from about 4,000 to about 7,000. In another embodiment, a high molecular weight diol suitable for the present invention will have a molecular weight of about 1,000 to about 6,000, a high molecular weight triol will have a molecular weight of about 3,000 to about 9,000, and a high molecular weight tetrol will have a molecular weight of about 4,000 to about 12,000. The molecular weight for the selected high molecular weight polyol or polyamine is about 1,000, about 2,000, about 2,500, about 3,000, about 3,500, about 4,000, about 4,500, about 5,000, about 5,500, about 6,000, about 7,000, about 8,000, about 9,500, or about 11,200. The selected polyols will generally have a hydroxyl number from about 10 to about 112, preferably the hydroxyl number is from about 10 to about 56, and more preferably from about 14 to about 28. Typically, useful high molecular weight components will have a viscosity from about 140 to about 3,000, from about 800 to about 2,800 or from about 1,500 to about 2,400 cP at 25° C. In a further embodiment, the polyol is a diol. Suitable high molecular weight polyols include, among others, the following commercially available products: Poly-G® 20-28 (a hydroxyl terminated poly(oxyalkelyene polyol)) available from Arch Chemicals and Acclaim 2220, Acclaim 4220, PPG-1000, PPG-2000, and PPG-4000 available from Bayer. Some examples of suitable high molecular weight amines include, but are not limited to, the following commercially available products: the Jeffamines® available from the Huntsman Corporation, such as Jeffamine® T-403 (poly(oxy(methyl-1,2-ethanediyl),alpha-hydro-omega-(2-aminomethylethoxy)-, ether with 2-ethyl-2-(hydroxymethyl)-1,3-propanediol (3:1)) and Jeffamine® D-2000 (a polyoxypropylenediamine).

Suitable polyisocyanates include, for example, MDI, poly MDI, methylenebis(cyclohexyl) isocyanate (H12MDI), tetramethyl xylene diisocyanate (TMXDI), isophorone diisocyanate (IPDI), and mixtures thereof. Additionally, the selected polyisocyanate may be a mixture of isomers. In one embodiment, a suitable polyisocyanate is any polyisocyanate (or misture of isocyanates) which contains an isomer that has a faster reactivity than a second isomer of the polyisocyanate. In one embodiment, the isocyanate is MDI. In a further embodiment the isocyanate is a mixture of 4,4′- and 2,4′-diphenylmethane diisocyanate, such as the following commercially available products: Mondur ML available from Bayer Co., Lupranate MI from BASF Co., or Rubinate 9433 from Huntsman. These commonly available formulations of MDI typically contain an approximately 50/50 mixture of the 2,4′ and the 4,4′ isomers of MDI, but mixtures having other ratios of these isomers are also appropriate for the invention as long as the mixture contains the 2,4′ isomer. Suitable poly MDI's include Lupranate M10, Lupranate M20S, and Lupranate M70R, and Lupranate M200 available from BASF.

As previously mentioned, a suitable proton donor is any active hydrogen compound from which a proton can be removed with a moderate base. In one embodiment, the proton donor may be a low molecular weight polyol and/or polyamine with various polymeric backbones, such as polyether, polyester, or polybutadiene. Such polyols and polyamines typically have a molecular weight less than about 400. In one embodiment, the molecular weight of the low molecular weight component is between about 60 and about 400, and in another embodiment between about 70 and about 325. In another embodiment, the molecular weight range is between about 80 and about 250, and in a further embodiment, the molecular weight range is between about 90 and about 190. In an additional embodiment, the molecular weight is about 134. The molecular weight of the low molecular weight polyol or polyamine may be about 60, about 70, about 80, about 90, about 110, about 134, about 150, about 165, about 180, about 200, about 250, about 325, or about 400. In one embodiment, the low molecular weight component contains from about 2 to about 12 carbon atoms. In another embodiment, the low molecular weight component is a diol. Suitable low molecular weight diols include, for example, di(propylene glycol), 1,3-butanediol, 1,4-butanediol, 1,6-hexanediol, 2-ethyl-1,3-hexanediol, 2-butyl-2-ethyl-1,3-propanediol, 2,4-diethyl-1,5-pentanediol, neopentyl glycol, ethylene glycol, propylene glycol, di(ethylene glycol), and 2-methyl-1,3-propane diol (MP Diol). Suitable low molecular weight difunctional amines include, for example, hydrazine, ethylene diamine, 1,4-butane diamine, 1,6-hexane diamine, and the commercially available products: PC Amine DA 145, PC Amine DA 176, PC amine DA 221, PC Amine DA 250, and PC Amine DA 400, available from Nitroil® Performance Chemicals.

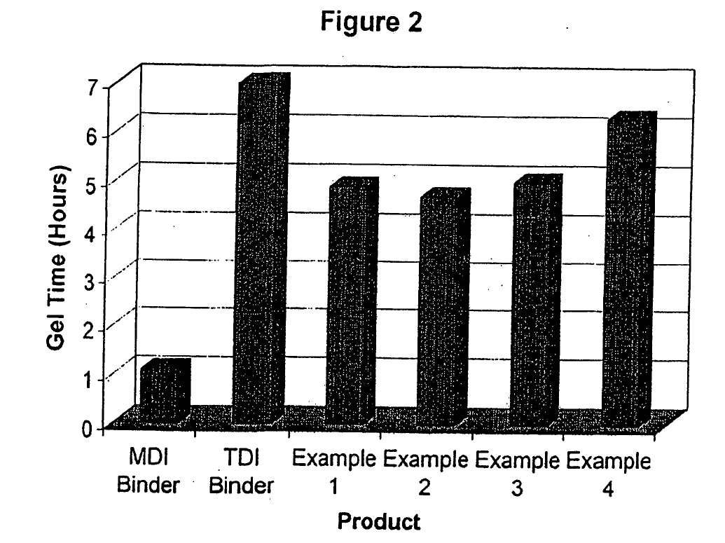

An adhesive formulation according to the invention can be obtained by a one-time reaction of the polyisocyanate, the high molecular weight component, and the low molecular weight component (i.e., proton donor). The polymerization reaction proceeds in atmospheric moisture without the addition of exogenous catalyst. In one embodiment, a formulation according to the present invention is obtained from a one-time reaction. In another embodiment, a formulation according to the present invention is obtained from a two step reaction wherein a stoichiometric excess of the polyisocyanate reacts with the low molecular weight component first, and then the unreacted isocyanate is further reacted with the high molecular weight component. The reaction of the polyisocyanate and the low molecular weight component (i.e., proton donor) typically is allowed to proceed for about 0.2 to about 4 hours, and preferably is allowed to proceed for about 0.5 to about 1.5 hours. More preferably, a formulation according to the invention is obtained from a two step reaction wherein the high molecular weight component is allowed to react with the polyisocyanate first, forming an isocyano terminated prepolymer, and then this prepolymer is allowed to react with the low molecular weight component. The reaction of the polyisocyanate and the high molecular weight component typically occurs for about 1 to about 6 hours and preferably about 1.5 to about 3 hours. Polyurethane adhesives prepared according to the invention may have an isocyanate group content of about 4 to about 12%, about 5 to about 10%, or about 7.5% by weight. The viscosity of the resulting adhesive may be about 2,000 to about 5,000, about 2,500 to about 3,500, or the viscosity may be about 3,000 cP at 25° C. By varying the components of the adhesive mixture, adhesives can be obtained having pot lives of up to about 16 or even up to about 24 hours or more at 25° C. and about 40% humidity. Pot life depends on temperature and humidity such that lower temperature and/or humidity increases pot life. FIG. 2 shows several gel times that were achieved with adhesives according to the present invention at 25° C. Gel time is an approximate measure of pot life. In some instances gel time will be longer than pot life and in other instances pot life may be longer than gel time. The selection of an adhesive according to its pot life is a user-defined variable and will depend upon an individual user's preferences and the particular application of the adhesive. Adhesives according to the present invention can be formulated to exhibit pot lives of greater than about 1.5 hours, or more desirably greater than about 2 hours, or more desirably between about 2 and about 16 hours, or more desirably between about 3 and about 10 hours at 25° C. and 50 to 80% humidity. For example, a pot life of between about 4 to about 7 hours at 25° C. and 50 to 80% humidity is desirable in the athletic track surfacing industry.

In one embodiment, the binders of the present invention are mixed with recycled rubber crumb to create a resilient surfacing material. The rubber that is mixed with a binder formulation according to the present invention may have any size, but in one embodiment is recycled rubber crumb (such as that from recycled tires) having a crumb size from about 0.3 to about 4.5 mm. The selection of crumb size typically depends on aesthetic and other concerns such as the price of the material and the ease of working with the resulting composite. A suitable composite of binder and rubber crumb will contain about 70 to about 95 by weight of rubber crumb and about 5 to about 30% by weight per hundred of adhesive binder. In another embodiment, a mixture of the binder and rubber crumb contains about 80 to about 90% by weight of the rubber crumb and about 10 to about 20% by weight of adhesive binder. Other materials can be substituted for the rubber crumb to make a composite for various applications, such as particles of plastic, wood, or cork, or glass fibers. After a composite, such as that of rubber crumb and adhesive, is applied or shaped as desired, the mixture hardens over time through reaction with atmospheric moisture. The mixture hardens faster at higher temperature and/or higher dew point. It is believed that hardening occurs by the hydrolysis of free isocyanate groups to create amino groups which then react with the remaining isocyanate groups to form polyurethaneurea.

The following examples are provided to further illustrate several embodiments of the invention. These examples are not meant to limit the scope of the invention.

### EXAMPLE 1

A resilient surface was prepared from a mixture of rubber crumb and binder. The binder was prepared by mixing 698 pairs by weight, e.g., grams, of a polyether polyol (a diol having a molecular weight of 4,000 (PPG-4000 available from Bayer)), with 7 parts by weight of di(propylene glycol), and 295 parts by weight of MDI (a 50/50 mixture by weight of 4,4′-diphenylmethane diisocyanate and 2,4′-diphenylmethane diisocyanate). The binder components were stirred for two hours at 80° C. to give a polyurethane pre-polymer as a colorless oil. The resulting pre-polymer binder had an isocyano (NCO) content of 8.0% by weight, a viscosity of 2,700 cP at 27° C. and a gel time of 4.9 hours at 25° C., 20.5° C. dewpoint, and 77% humidity. The cured film of the binder had a tensile strength of 2,121 psi and an elongation of 622%.

A mixture was made of 200 g of the pre-polymer binder and 800 g of recycled rubber crumb having a grain size from 1 to 3 mm. The mixture was stirred until the rubber crumbs were completely wetted with binder and then was poured into a 48×30×2 cm pan. The mixture was shaped with a roller to a uniform thickness of 9.5 to 10.5 mm. The resulting rubber sheet was cured for 7 days at room temperature in the presence of atmospheric moisture. This composite was found to have good physical properties.

### EXAMPLE 2

An adhesive binder was prepared by stirring 7 parts by weight of di(propylene glycol) with 295 parts by weight of MDI (a 50/50 by weight mixture of 4,4′-diphenylmethane diisocyanate and 2,4′-diphenylmethane diisocyanate) for one hour at 35-55° C. A polyether polyol (a diol having a molecular weight of 4,000 (PPG-4000 available from Bayer)), 698 parts by weight, was then added and the mixture was stirred for two additional hours at 80° C. The resulting polyurethane binder was a colorless oil with a NCO content of 8.0% by weight, a viscosity of 2,800 cP at 26° C., and a gel time of 4.7 hours at 25° C., 22° C. dewpoint, and 84% humidity. The cured film of the polyurethane binder had a tensile strength of 2,080 psi and an elongation of 630%.

A mixture was made of 200 g of the polyurethane binder and 800 g of recycled rubber crumb having a grain size of 1 to 3 mm. The mixture was stirred until the rubber crumbs were completely wetted with binder and then about half of the mixture was poured into a 48×30×2 cm pan. The binder and rubber crumb mixture in the pan was shaped with a roller into a mat having a uniform thickness of 9.5 to 10.5 cm and allowed to cure for 6 hours at room temperature. The remainder of the rubber mixture was then poured next to the first mat and shaped with a roller to a uniform thickness of 9.5 to 10.5 cm. After curing for 7 days at room temperature in the presence of atmospheric moisture, the two rubber mats were found to have formed a seamless joint.

### EXAMPLE 3

An adhesive binder was prepared by mixing 698 parts by weight of a polyether polyol (a diol with a molecular weight of 4,000 (PPG-4000 available from Bayer)), 295 parts by weight of MDI (a 50/50 mixture by weight of 4,4′-diphenylmethane diisocyanate and 2,4′-diphenylmethane diisocyanate). This mixture was stirred for two hours at 80° C. and cooled to 65° C. Seven parts by weight of di(propylene glycol) were then added and this mixture was stirred for one hour at about 40 to 65° C. The resulting polyurethane binder was obtained as a colorless oil and has a NCO content of 8.0% by weight, a viscosity of 3,200 cP at 25° C., and a gel time of 5 hours at 25° C., 18° C. dewpoint, and 64% humidity. A cured film of the binder had a tensile strength of 2,160 psi and an elongation of 590%.

A mixture was made of 200 g of the polyurethane binder and 800 g of recycled rubber crumb having a grain size of 1 to 3 mm and the mixture was stirred until the rubber crumbs were completely wetted with binder. About half of the mixture was poured into a 48×30×2 cm pan. The binder and rubber crumb mixture in the pan was shaped with a roller into a mat having a uniform thickness of 9.5 to 10.5 cm and allowed to cure for 4 hours at 30-36° C. in the sunlight. The remainder of the rubber mixture was then poured next to the first mat and shaped with a roller to a uniform thickness of 9.5 to 10.5 cm. After curing for 7 days outdoors at 24 to 38° C. in the presence of atmospheric moisture, the two rubber mats were found to formed a joint without a discernable seam.

### EXAMPLE 4

An adhesive binder was prepared by mixing 762 parts by weight of a polyether polyol (a diol having a molecular weight of 4,000 (PPG-4000 available from Bayer)), with 10 parts by weight of di(propylene glycol), and 228 parts by weight of MDI (a 50/50 mixture by weight of 4,4′-diphenylmethane diisocyanate and 2,4′-diphenylmethane diisocyanate). The binder components were stirred for two hours at 80° C. to give a polyurethane pre-polymer as a colorless oil. The resulting pre-polymer binder had a NCO content of 5.4% by weight, a viscosity of 2,600 cP at 28° C. and a gel time of 6.3 hours at 25° C., 18° C. dewpoint, and 64% humidity. A cured film of the binder had a tensile strength of 1,148 psi and an elongation of 542%.

A mixture was made of 200 g of the polyurethane binder and 800 g of recycled rubber crumb having a grain size of 1 to 3 mm and the mixture was stirred until the rubber crumbs were completely wetted with binder. About half of the mixture was poured into a 48×30×2 cm pan. The binder and rubber crumb mixture in the pan was shaped with a roller into a mat having a uniform thickness of 9.5 to 10.5 cm and allowed to cure for 6 hours at room temperature. The remainder of the rubber mixture was then poured next to the first mat and shaped with a roller to a uniform thickness of 9.5 to 10.5 cm. After curing for 7 days at room temperature in the presence of atmospheric moisture, the two rubber mats were found to be joined together without a discernable seam.

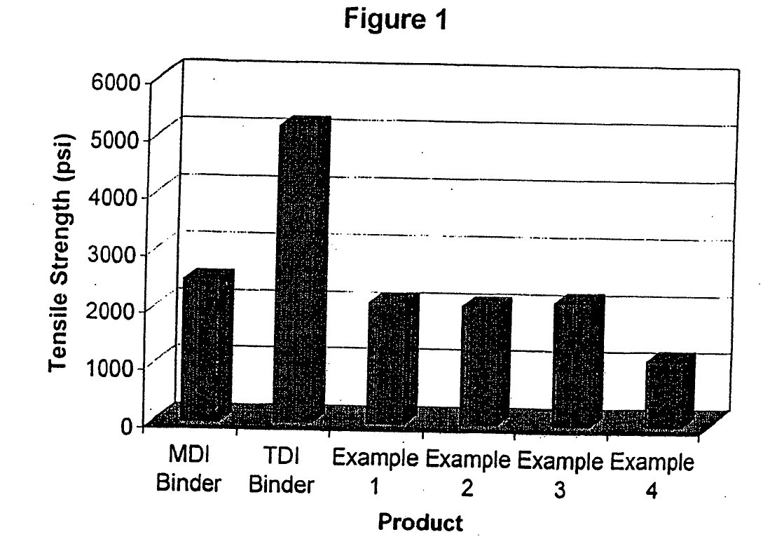

FIG. 1 compares measurements of the tensile strength of films of the prior art binders to the measured tensile strengths of thin films of the binders prepared according the examples given above. FIG. 2 compares the gel times for the MDI binder and TDI-containing binder to the gel times measured for the binders prepared according to the examples given above. Gel times in these examples were measured at approximately 25° C. and about 50 to about 80% humidity. Measurements were made under this temperature and humidity because these conditions approximate typical conditions found outdoors in the summertime, but the binders of the present invention can also be used at other temperatures and humidities. It can be seen from FIG. 2 that the addition of the chain extender significantly increases the gel time over the gel time observed for the MDI-only binder. Composites of binder and rubber prepared from binders formulated according to the present invention exhibit good physical properties such as good values for tensile strength and elongation.

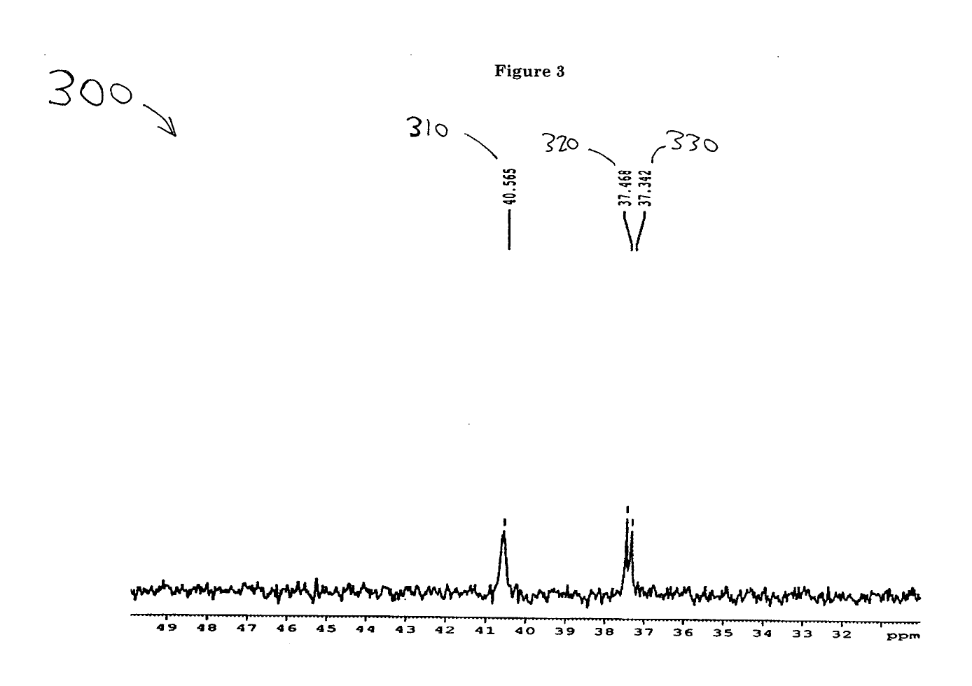

FIG. 3 depicts one embodiment of an ¹³C NMR spectra 300 of a prepolymer prepared in accordance with the Example 1 described above. It is believed that peaks in the field of 42 ppm to 36 ppm are MDI methylene carbon peaks. In particular, peak 310 is believed to be 4,4-MDI methylene carbon and is seen in the range of 40.57 ppm to 40.83 ppm. It is further believed that peak 320 is 2,4-MDI methylene carbon and is seen in the range of 37.47 ppm to 37.65 ppm. In addition, it is also believed that peak 330 is 2,4-MDI methylene carbon with its 4-NCO blocked by a chain extender. Peak 330 is at 37.34 ppm as shown in NMR spectrum 300.

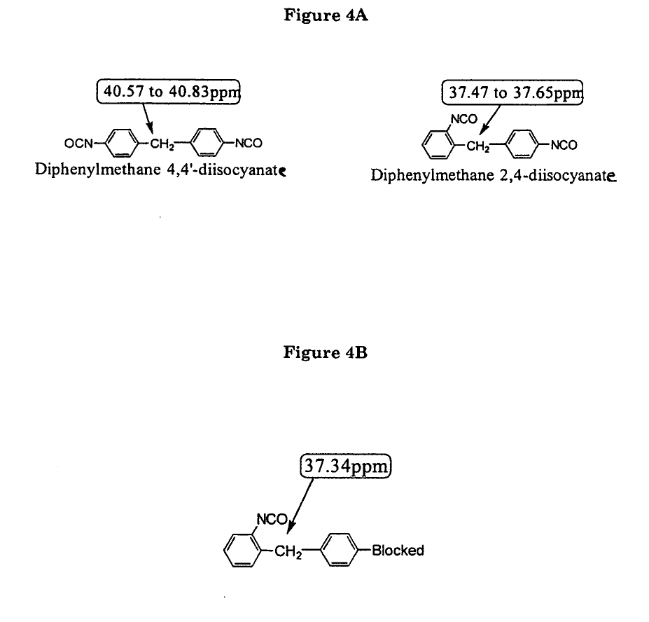

Referring now to FIG. 4A depicted is one embodiment of a molecular representation of the 4,4-MDI methylene carbon and 2,4-MDI methylene carbon of FIG. 3. In addition, FIG. 4B is one embodiment of a molecular representation of the 4-NCO blocked 2,4-MDI methylene carbon of FIG. 3. As previously mentioned, a proton donor is used to react off the 4-position isocyano group in order to increase the relative amount of 2-position isocyanate. This mechanism is reflected in the molecular representation of FIG. 4B and in the previously-mentioned peak 330.

It will be understood that the various modifications may be made to the embodiments disclosed herein. For example, the disclosed formula could be made using many different polyisocyanates and could be used wherever a moisture-curing polyurethane adhesive with a long pot life is desired. Therefore, the above description should not be construed as limiting, but merely as examples of some of the preferred embodiments.

What is claimed is:

1. An adhesive polyurethane composition comprising a high molecular weight component selected from the group consisting of polyols, polyamines, and mixtures thereof, a proton donor; and a polyisocyanate comprised of a mixture of a first isocyanate isomer and a second isocyanate isomer, wherein said first isocyanate isomer has a faster reaction rate than said second isocyanate isomer, and wherein said first isocyanate isomer reacts with said proton donor to increase a relative concentration of said second isocyanate isomer as a percentage of total unreacted isocyantes.

2. The adhesive polyurethane composition claim 1, wherein said adhesive polyurethane composition exhibits a pot life of greater than about 1.5 hours at 25° C. and 50 to 80% humidity.

3. The adhesive polyurethane composition claim 1, wherein a resulting adhesive composition has an isocyanate group content of about 4 to about 12% by weight.

4. The adhesive polyurethane composition of claim 1, wherein said proton donor is a low molecular weight diol and said polyisocyanate is one of MDI and polyMDI.

5. The adhesive polyurethane composition of claim 1, wherein said first isocyanate isomer is a 4-position isocyanate found in 4,4′-diphenylmethane diisocyanate and 2,4′-diphenylmethane diisocyanate, and wherein said second isocyanate isomer is a 2-position isocyanate found in 2,4′-diphenylmethane diisocyanate.

6. The adhesive polyurethane composition of claim 1, wherein the proton donor is a diol containing from about 2 to about 12 carbon atoms.

7. The adhesive polyurethane composition of claim 1, wherein the proton donor is a chain extender.

8. The adhesive polyurethane composition of claim 1, wherein said proton donor serves to increase said adhesive polyurethane composition's pot life.

9. The adhesive polyurethane composition of claim 1, wherein said proton donor is an n-functional proton donor, where n varies from 1 to 8.

10. The adhesive polyurethane composition of claim 1, wherein the proton donor is any active hydrogen compound from which a proton can be removed with a moderate base.

11. The adhesive polyurethane composition of claim 1, wherein the mixture contains about 60 to about 80% by weight of the high molecular weight component, about 19 to about 38% by weight of the polyisocyanate, and about 0.1 to about 3% by weight of the proton donor.

12. The adhesive polyurethane composition of claim 1, wherein said adhesive composition is obtained a one-time reaction of said polyisocyanate, the high molecular weight component, and the proton donor.

13. The adhesive polyurethane composition of claim 1, wherein said adhesive composition is obtained from a first reaction and a second reaction, wherein said first reaction comprises reacting a stoichiometric excess of said polyisocyanate with said proton donor, and wherein said second reaction comprises reacting unreacted isocyanate with said high molecular weight component.

14. The adhesive polyurethane composition of claim 1, wherein said adhesive composition is obtained from a first reaction and a second reaction, wherein said first reaction comprises reacting said high molecular weight component with said polyisocyanate to form an isocyano terminated prepolymer, and wherein said second reaction comprises reacting said isocyano terminated prepolymer with said proton donor.

15. An adhesive polyurethane composition comprising:
a) about 50 to about 80% by weight of a high molecular weight component selected from the group consisting of polyols, polyamines, and mixtures of polyols and polyamines;
b) about 19 to about 44% by weight of a polyisocyanate comprised of a first isocyanate isomer and a second isocyanate isomer, wherein said first isocyanate isomer has a faster reaction rate than said second isocyanate isomer; and
c) about 0.1 to about 3% by weight of a proton donor compound, wherein said first isocyanate isomer reacts with said proton donor to increase a relative concentration of said second isocyanate isomer as a percentage of total unreacted isocyantes.

16. The adhesive polyurethane composition claim 15, wherein said adhesive polyurethane composition exhibits a pot life of greater than about 1.5 hours at 25° C. and 50 to 80% humidity.

17. The adhesive polyurethane composition of claim 15, wherein a resulting adhesive composition has an isocyanate group content of about 4 to about 12% by weight.

18. The adhesive polyurethane composition of claim 15, wherein said proton donor is a low molecular weight diol and said polyisocyanate is one of MDI and polyMDI.

19. The adhesive polyurethane composition of claim 15, wherein said first isocyanate isomer is a 4-position isocyanate found in 4,4′-diphenylmethane diisocyanate and 2,4′-diphenylmethane diisocyanate, and wherein said second isocyanate isomer is a 2-position isocyanate found in 2,4′-diphenylmethane diisocyanate.

20. The adhesive polyurethane composition of claim 15, wherein the proton donor compound is a diol containing from about 2 to about 12 carbon atoms.

21. The adhesive polyurethane composition of claim 15, wherein the proton donor is a chain extender.

22. The adhesive polyurethane composition of claim 15, wherein the proton donor is any active hydrogen compound from which a proton can be removed with a moderate base.

23. The adhesive polyurethane composition of claim 15, wherein said proton donor serves to increase said adhesive polyurethane composition's pot life.

24. The adhesive polyurethane composition of claim 15, wherein said proton donor is an n-functional proton donor, where n varies from 1 to 8.

25. The adhesive polyurethane composition of claim 15, wherein said adhesive polyurethane composition is obtained a one-time reaction of said polyisocyanate, the high molecular weight component, and the proton donor compound.

26. The adhesive polyurethane composition of claim 15, wherein said adhesive polyurethane composition is obtained from a first reaction and a second reaction, wherein said first reaction comprises reacting a stoichiometric excess of said polyisocyanate with said proton donor compound, and wherein said second reaction comprises reacting unreacted isocyanate with said high molecular weight component.

27. The adhesive polyurethane composition of claim 15, wherein said adhesive polyurethane composition is obtained from a first reaction and a second reaction, wherein said first reaction comprises reacting said high molecular weight component with said polyisocyanate to form an isocyano terminated prepolymer, and wherein said second reaction comprises reacting said isocyano terminated prepolymer with said proton donor compound.

28. A method of producing a adhesive polyurethane composition comprising:
reacting a high molecular weight component with a polyisocyanate to form an isocyano terminated prepolymer, wherein said high molecular weight component is selected from the group consisting of polyols, polyamines and mixtures thereof, and wherein said polyisocyanate is comprised of a first isocyanate isomer and a second isocyanate isomer in which said first isocyanate isomer has a faster reaction rate than said second isocyanate isomer; and
reacting said isocyano terminated prepolymer with a proton donor to increase a relative concentration of said second isocyanate isomer to first isocyanate isomer.

29. The method of claim 28, wherein said adhesive polyurethane composition exhibits a pot life of greater than about 1.5 hours at 25° C. and 50% to 80% humidity.

30. The method of claim 28, wherein a resulting adhesive composition has an isocyanate group content of about 4 to about 12% by weight.

31. The method of claim 28, wherein the proton donor is a diol containing from about 2 to about 12 carbon atoms.

32. The method of claim 31, wherein the diol is selected from the group consisting of di(propylene glycol), 1,3-butanediol, 1,4-butanediol, 1,6-hexanediol, 2-ethyl-1,3-hexanediol, 2-butyl-2-ethyl-1,3-propanediol, 2,4-diethyl-1,5-pentanediol, di(ethylene glycol), neopentyl glycol, ethylene glycol, propylene glycol, 2-methyl-1,3-propane diol, and mixtures thereof.

33. The method of claim 28, wherein the proton donor is a low molecular weight component having a molecular weight from about 60 to about 400.

34. The method of claim 28, wherein the proton donor is a chain extender.

35. The method of claim 28, wherein the proton donor is any active hydrogen compound from which a proton can be removed with a moderate base.

36. The method of claim 28, wherein said proton donor serves to increase said adhesive polyurethane composition's pot life.

37. The method of claim 28, wherein said proton donor is an n-functional proton donor, where n varies from 1 to 8.

38. The method of claim 28, further comprising mixing said moisture-curing adhesive polyurethane composition with a component selected from the group consisting of rubber crumb, cork particles, plastic particles, glass fibers, and mixtures thereof.

39. The method of claim 28, further comprising mixing said moisture-curing adhesive polyurethane composition with about 70 to about 95 parts of rubber crumb and about 5 to about 30% by weight of resin.

40. The method of claim 28, wherein said first isocyanate isomer is a 4-position isocyanate found in 4,4′-diphenylmethane diisocyanate and 2,4′-diphenylmethane diisocyanate, and wherein said second isocyanate isomer is a 2-position isocyanate found in 2,4′-diphenylmethane diisocyanate.
